(19) United States
(12) Patent Application Publication
(10) Pub. No.: US 2008/0196772 A1
(43) Pub. Date: Aug. 21, 2008

(54) Overflow Shutoff Valve For Liquified Gas Container

(76) Inventor: Il-Hwan Shin, Seoul (KR)

Correspondence Address: IPLA P.A., 3580 WILSHIRE BLVD., 17TH FLOOR, LOS ANGELES, CA, 90010, US

(21) Appl. No.: 11/995,232

(22) PCT Filed: Sep. 21, 2005
(86) PCT No.: PCT/KR2005/003116

§ 371 Date: Jan. 10, 2008

(30) Foreign Application Priority Data
Jul. 29, 2005 (KR) 10-2005-0069497
Sep. 21, 2005 (KR) PCT/KR2005/003116

(51) Int. Cl. F17C 13/04; F16K 17/34

(52) U.S. Cl. 137/484.6

(57) ABSTRACT

Disclosed herein is an over-flow shutoff valve for a liquefied petroleum gas container The overflow shutoff valve includes: a gas inlet mounted at the gas container; a safety valve protrudingly formed at one side of the upper portion of the gas inlet for discharging the internal pressure of the gas container when the internal pressure is rapidly increased; a gas outlet protrudingly formed at the other side of the upper portion of the gas inlet for supplying gas to a gas appliance; a valve handle for vertically controlling a valve stem mounted on a controlling part protruding from the upper portion of the gas inlet; a gas inflow and outflow hole located between the gas inlet and the controlling part for allowing inflow and outflow of the gas; a cylinder fit into the inner circumference of the gas inlet; and a ball positioned inside the cylinder, the cylinder and the ball being adapted to normally discharge the gas contained in the gas container and regulate a gas flow to prevent an excessive outflow of the gas, wherein the cylinder has an upper part, a lower part and an intermediate part between the upper and lower parts, each of which has the same thickness, and is made of a hollow pipe, the upper part having a plurality of upper incised slots of a uniform length vertically formed on the circumference thereof in an axial direction in such a manner as to be spaced apart from one another at regular intervals and be opened upwardly, and the lower part having a plurality of lower incised slots of a uniform length vertically formed on the circumference thereof in the axial direction in such a manner as to be spaced apart from one another at regular intervals and be opened downwardly.

### TECHNICAL FIELD

The present invention relates to an overflow shutoff valve for a liquefied petroleum gas container, on which a cylinder of an improved structure is mounted, thereby normally supplying gas, automatically shutting off a gas flow when the gas is excessively discharged abnormally, and reducing a recovery time period when the remaining gas contained in the gas container is recovered before the gas container is refilled with gas and a refilling time period when the gas container is refilled with the gas.

### BACKGROUND ART

In general, it is prescribed in the relevant law that a liquefied petroleum gas container shall be provided with an overflow shutoff valve for normally supplying gas and automatically shutting off the gas when the gas is excessively discharged from a gas heating appliance (for example, a gas oven range, a gas boiler, and so on) or when the gas is excessively discharged since a hose for supplying the gas is out of order.

Conventional gas shutoff valves are respectively disclosed in Korean Patent Laid-Open Publication No. 1998-087033 and Korean Patent No. 10-0302971, and shown in FIGS. 8 to 10.

All of the above conventional gas shutoff valves 100A, 100B and 100c shown in FIGS. 8 to 10 include a gas inlet 110, a safety valve 120, a gas outlet 130, and a valve handle 140. Each gas shutoff valve is provided with a cylinder structure mounted on the gas inlet 110, but such a cylinder structure has the following problems.

First, in the gas shutoff valve 100A shown in FIG. 8, a cylinder 200 mounted on the gas inlet 110 includes: a screwing part 210 screwed with a female screw part formed at the lower portion of a gas inflow and outflow hole 150; a cylindrical part 220 formed integrally with the screwing part 210 and having the outer diameter smaller than that of the screwing part 210; upper discharge holes 230 formed at the upper portion of the cylindrical part 220 and beneath the screwing part 210 in such a manner as to face each other; lower discharge holes 240 formed at the lower portion of the cylindrical part 220 in such a manner as to face each other; a ball 250 positioned inside the cylindrical part 220 of the cylinder 200 and having a diameter almost equal to the inner diameter of the cylindrical part 220 for opening and closing the cylindrical part 220; and a spring 260 fit on the inner circumferential surface of the cylindrical part 220 for supporting the ball 250. In the cylinder 200, the ball 250 is positioned at the location A shown in the drawing when gas is discharged normally. Since the ball 250 is in a close contact with the inner circumference of the cylindrical part 220, the gas induced into the gas inlet 110 does not flow to the cylindrical part 220 due to the ball 250, passes a passageway 270 formed on the outer circumference of the cylindrical part 220 through the lower discharge holes 240, and is induced to the upper portion of the cylindrical part 220 through the upper discharge holes 230, so that the gas can be normally supplied through the gas inflow and outflow hole 150. If the gas is not discharged to the gas outlet 130 in normal but is excessively discharged in abnormal, the ball 250 is moved to the location B shown in the drawing by gas pressure induced to the gas inlet 110 and positioned at the inside of the screwing part 210. At this time, the ball 250 shuts off a gas flow to the gas inflow and outflow hole 150, and hence, the gas is prevented from being discharged to the gas outlet 130 in abnormal, and accidents occurring due to overflow of the gas can be prevented.

However, the prior art shown in FIG. 8 has a disadvantage in that a recovery time period and a refilling time period are too long when remaining gas contained in the gas container is recovered in order to refill a gas container with gas after exhausting the gas charged in the gas container (bombe).

That is, when the gas container is turned upside down for recovering the remaining gas of the gas container through the gas outlet 130, since the ball 250 is moved to the location B of the drawing by self-weight, the remaining gas induced into the gas inlet 110 flows through a fine gap formed between the ball 250 and the inner circumferential surface of the cylindrical part 220 (more particularly, the inner diameter of the screwing part), whereby the recovery time period of the remaining gas is extended. On the contrary, when the gas refills the gas container through the gas outlet 130 after the recovery of the remaining gas, since the ball 250 compresses the spring 260 and moves to the location C shown in the drawing by pressure of the refilling gas, the refilling gas is induced into the cylinder 200 through the gas inflow and outflow hole 150. At this time, the ball 250 stops the inside of the cylindrical part 220, so that the gas induced into the gas inflow and outflow hole 150 passes the passageway 270 formed on the outer circumference of the cylindrical part 220 through the upper discharge holes 230, is induced into the lower portion of the cylindrical part 220 through the lower discharge holes 240, and refills the gas container through the gas inlet 110. Since a flow amount of the gas flowing through the upper and lower discharge holes 230 and 240 is smaller than an inflow amount of the gas induced into the gas inflow and outflow hole 150 when the gas container is refilled with gas, the refilling time period is extended.

The reason is that a sectional area of each of the upper and lower discharge holes 230 and 240 formed on the upper and lower portions of the cylindrical part 220 of the cylinder 200 by two is smaller than a sectional area of the gas inflow and outflow hole 150. To solve the above problem, if each of the upper and lower discharge holes 230 and 240 has the same sectional area as the gas inflow and outflow hole 150, strength of the cylinder 200 becomes weaker. As a result, when the cylindrical part 220 is rotated in order to screw-engage the screwing part 210 with a female screw portion formed beneath the gas inflow and outflow hole 150, the upper discharge holes 230 which are larger are broken or distorted. Therefore, in case of the gas shutoff valve 100A shown in FIG. 8, in consideration of strength of the cylinder 200, the upper and lower discharge holes 230 and 240 have to be formed in a incised slot type, so that the recovery and refilling time periods of the remaining gas contained in the gas container takes much time.

Next, the conventional gas shutoff valve 100B shown in FIG. 9 is proposed to solve the problems of the cylinder 200 of the gas shutoff valve 100 shown in FIG. 8. A cylinder 300 mounted on a gas inlet 110 formed under a gas inflow and outflow hole 150 of the gas shutoff valve 100B includes: a screwing part 310 screw-engaged to a female screw portion formed on the lower portion of the inner wall of the gas inlet 110; a cylindrical part 320 formed integrally with the screwing part 310 and having a diameter smaller than that of the screwing part 310, the cylindrical part 320 being stepped in such a manner that an upper inside wall surface 330 thereof is wider but a lower inside wall surface 340 thereof is narrower; a pair of upper discharge holes 350 formed at the upper portion of the upper inside wall surface 330 in such a manner as to face each other; a pair of lower discharge holes 360 formed at the lower portion of the lower inside wall surface 340 in such a manner as to face each other; a ball 370 positioned inside the cylindrical part 320 and having a diameter almost equal to the inner diameter of the lower inside wall surface 340 of the cylindrical part 320; and a spring 380 fit on the inner circumferential surface of the cylindrical part 320 for supporting the ball 370. Also the gas shutoff valve 100B shown in FIG. 9 has several disadvantages in that the recovery time period is extended when the remaining gas of the gas container is recovered, and in that the spring 380 for supporting the ball 370 is not returned to its original position after the refilling of the gas.

That is, also in the gas shutoff valve 100B shown in FIG. 9, the ball 370 is located at the position D shown in the drawing when the gas is discharged normally. At this time, the ball 370 stops the lower inside wall surface 340 of the cylindrical part 320, whereby the gas discharged through the gas inlet 110 passes a passageway 390 formed on the outer circumference of the cylindrical part 320 through the lower discharge holes 360, is induced into the upper inside wall surface 330 of the cylindrical part 320 through the upper discharge holes 350, and discharged to the gas outlet 130 through the gas inflow and outflow hole 150. If the gas is excessively discharged through the gas outlet 130 in abnormal, discharge pressure of the gas moves the ball 370 upwardly, so that the gas inflow and outflow hole 150 is stopped and the gas is shut off so as to prevent the excessive discharge of the gas. However, to recover the remaining gas of the gas container, after a valve handle 140 is rotated and a ball support pin 141 is inserted into the gas inflow and outflow hole 150, when the gas container is turned upside down, the ball 370 is moved to the position E shown in the drawing by its self-weight. At this time, since a sectional area of a gap formed between the upper inside wall surface 330 and the ball 370 is smaller than that of the gas inflow and outflow hole 150, the remaining gas is not smoothly discharged to the gas inflow and outflow hole 150, and as a result, the recovery time period of the remaining gas is extended. On the contrary, when the gas container is refilled with gas, the ball 370 compresses the spring 380 by gas pressure induced into the gas outlet 130, and is moved to the position F shown in the drawing. At this time, the inside wall surface of the screwing part 310 on which the ball is located is larger than the upper inside wall surface 330 of the cylindrical part 320, so that the sectional area of the gap formed between the inside wall surface the screwing part 310 and the ball 370 becomes almost equal to the sectional area of the gas inflow and outflow hole 150. As a result, the gas container is smoothly refilled with the gas, so that the refilling time period of the gas can be reduced. Since the spring 380 is in a compressed state inside the screwing part 310 by the ball 370 during the refilling of the gas, the upper end of the spring 380 may be caught by a stepped jaw formed between the screwing part 310 and the cylindrical part 320 when the spring 380 is elastically restored to its original position after the refilling of the gas. If the upper end of the spring 380 is caught by the stepped jaw, the spring 380 cannot support the ball 370 at the upper portion of the lower discharge hole 360, whereby the ball 370 stops the lower discharge hole 360 and the gas cannot be supplied normally.

Also the gas shutoff valve 100C shown in FIG. 10 includes a gas inlet 110 mounted on the gas container for inducement of the gas contained in the gas container, a safety valve 120, a gas outlet 130, a valve handle 140, and a cylinder 400 mounted on the gas inlet 110. The cylinder 400 includes an upper part 410 and a lower part 420 which are thin, and a central part 430 which is thick and has a protrusion 431 protruding inwardly. The lower part 420 of the cylinder 400 is supported by a cylinder supporter 440 screwed to the lower end of the gas inlet 110. The cylinder 400 further includes a pin shaft 450 mounted inside the cylinder 400 and vertically supported in a state where the pin shaft 450 is fit into a pin supporter 441 formed at the center of the cylinder supporter 440 to be moved vertically, a disc 460 movably fit onto the central portion of the pin shaft 450, a valve plate 470 integrally formed on the upper end of the pin shaft 450, and upper and lower springs 480 and 490 mounted between the pin supporter 441 and the disc 460 and between the disc 460 and the valve plate 470.

Meanwhile, the cylinder 400 shown in FIG. 10 has a hole 411 formed on a side of the upper part 410 to communicate with the safety valve 120.

When the cylinder 400 discharges the gas normally, as indicated by a solid line of FIG. 10, the disc 460 supported by the upper and lower springs 480 and 490 is located on the lower portion of the central part 430, and the valve plate 470 is located at a position which is deviated upwardly from the upper end of the protrusion 431. Since the outer diameter of the disc 460 is smaller than the inner diameter of the protrusion 431, the gas induced into the cylinder 400 through the gas inlet 110 flows through a gap formed between the protrusion 431 and the disc 460, passes the gas inflow and outflow hole 150, and is supplied to the gas outlet 130. When the gas is excessively discharged in abnormal, the disc 460 is moved upwardly by gas pressure, and at the same time, also the valve plate 470 is moved upwardly, so that the gas inflow and outflow hole 150 is stopped in order to prevent the excessive discharge of the gas. Since the pin shaft 450 supporting the disc 460 and the valve plate 470 for controlling inflow and outflow of the gas inside the cylinder 400 shown in FIG. 10 is made of a thin metallic material, the pin shaft 450 may be bent by gas pressure during the recovery and refilling of the gas. In addition, the pin shaft 450 may be caught by the lower end of the protrusion 431 when the disc 460 is returned to its original position by elasticity of the lower spring 490 after the refilling of the gas.

That is, when the remaining gas contained in the gas container is recovered, if the recovered gas pressure does not act uniformly to the entire disc 460, the disc 460 may be inclined to a side, whereby pressure for bending the pin shaft 450 is generated. If the remaining gas is repeatedly recovered to fill the gas container with gas, it is quite probable that the pin shaft 450 is bent. If the pin shaft 450 is bent, the disc 460 and the valve plate 470 are not operated normally, and so, the gas shutoff valve 100C may be out of order if it is used for a long time. Furthermore, during the refilling of the gas, the disc 460 and the valve plate 470 compress the upper and lower springs 480 and 490 by gas pressure induced into the gas outlet 130, and are moved to a position indicated by a virtual line of FIG. 10. As described above, when the gas container is refilled with the gas, the disc 460 and the valve plate 470 may make the pin shaft 450 bent even while they are moved to the indicated position from the lower end of the protrusion 431. In addition, after completion of the refilling, while the disc 460 and the valve plate 470 are returned to their original positions by resilient restoring force of the upper and lower springs 480 and 490, the valve plate 470 which has the upper surface being in the form of a sphere is not caught by the lower end of the protrusion 431, but the periphery of the disc 460 which has the upper surface of a flat type may be caught by the lower end of the protrusion 431, and hence, it deteriorates safety and reliability in use of the gas container.

Meanwhile, each of the cylinders of the conventional gas shutoff valves has a single layer structure, and thus, the cylinders have several problems in that a manufacturing cost of the gas shutoff valve becomes increased since lots of materials are needed and a processing cost rises.

### DISCLOSURE OF INVENTION

### Technical Problem

Accordingly, the present invention has been made in view of the above-mentioned problems occurring in the prior art, and it is an object of the present invention to provide an overflow shutoff valve for a liquefied petroleum gas container, on which an improved cylinder is mounted, thereby reducing a material cost and a processing cost of the cylinder, and shortening time period for recovery and refilling of remaining gas which are the most important functions of the overflow shutoff valve.

### Technical Solution

To achieve the above object, according to the invention, there is provided an overflow shutoff valve for a liquefied petroleum gas container, which includes: a gas inlet mounted at the gas container; a safety valve protrudingly formed at one side of the upper portion of the gas inlet for discharging the internal pressure of the gas container when the internal pressure is rapidly increased; a gas outlet protrudingly formed at the other side of the upper portion of the gas inlet for supplying gas to a gas appliance; a valve handle for vertically controlling a valve stem mounted on a controlling part protruding from the upper portion of the gas inlet; a gas inflow and outflow hole located between the gas inlet and the controlling part for allowing inflow and outflow of the gas; a cylinder fit into the inner circumference of the gas inlet; and a ball positioned inside the cylinder, the cylinder and the ball being adapted to normally discharge the gas contained in the gas container and regulate a gas flow to prevent an excessive outflow of the gas, wherein the cylinder has an upper part, a lower part and an intermediate part between the upper and lower parts, each of which has the same thickness, and is made of a hollow pipe, the upper part having a plurality of upper incised slots of a uniform length vertically formed on the circumference thereof in an axial direction in such a manner as to be spaced apart from one another at regular intervals and be opened upwardly, and the lower part having a plurality of lower incised slots of a uniform length vertically formed on the circumference thereof in the axial direction in such a manner as to be spaced apart from one another at regular intervals and be opened downwardly.

Preferably, four to six upper incised slots and four to six lower incised slots may be respectively formed in the upper and lower parts of the cylinder so that the sum of plane sectional areas of the upper and lower incised slots respectively formed in the upper and lower parts of the cylinder is greater than a plane sectional area of the gas inflow and outflow hole.

Also, preferably, the inner diameter of the cylinder may be larger than the diameter of the ball.

### Advantageous Effects

According to the present invention, the gas contained in the gas container can be normally discharged, overflow of the gas can be prevented, and the recovery time period and the refilling time period of the remaining gas of the gas container are reduced. Moreover, the cylinder of the present invention does not have any stepped layer like the prior arts but has a simple structure that a number of the upper and lower incised slots are respectively formed in the upper and lower parts of the hollow pipe, whereby a manufacturing cost of the overflow shutoff valve can be reduced by saving material expenses and processing expenses of the cylinder.

### BRIEF DESCRIPTION OF THE DRAWINGS

Further objects and advantages of the invention can be more fully understood from the following detailed description taken in conjunction with the accompanying drawings in which:

FIG. 1 is a sectional view showing an operation state wherein an overflow shutoff valve is actuated when gas is supplied normally;

FIG. 2 is a sectional view taken along the line of A-A of FIG. 1;

FIG. 3 is a perspective view of a cylinder mounted on the overflow shutoff valve according to the present invention;

FIG. 4 is a sectional view showing a state wherein the overflow shutoff valve is actuated to stop a gas flow when the gas is overflowed;

FIG. 5 is a sectional view showing an operation state of the overflow shutoff valve when the gas is recovered;

FIG. 6 is a sectional view showing an operation state of the overflow shutoff valve when a gas container is refilled with the gas;

FIG. 7 is a sectional view taken along the line of B-B of FIG. 6; and

FIGS. 8 to 10 are sectional views of a conventional gas shutoff valve.

### MODE FOR THE INVENTION

Reference will now be made in detail to the preferred embodiments of the present invention, examples of which are illustrated in the accompanying drawings.

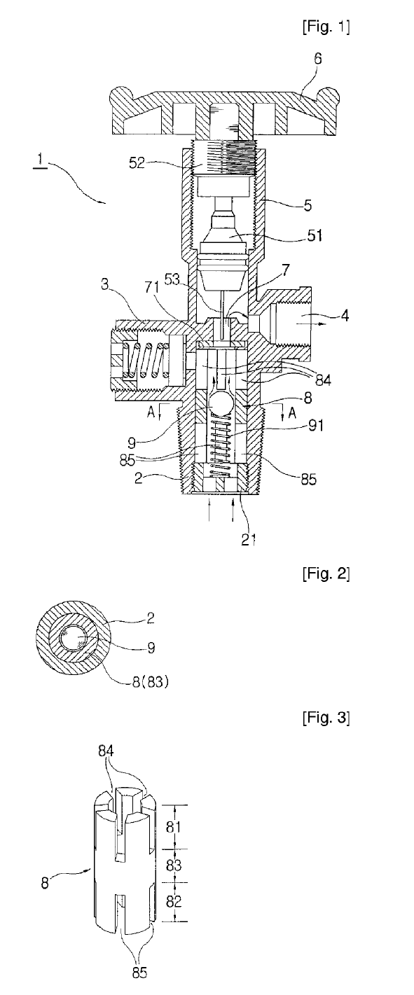

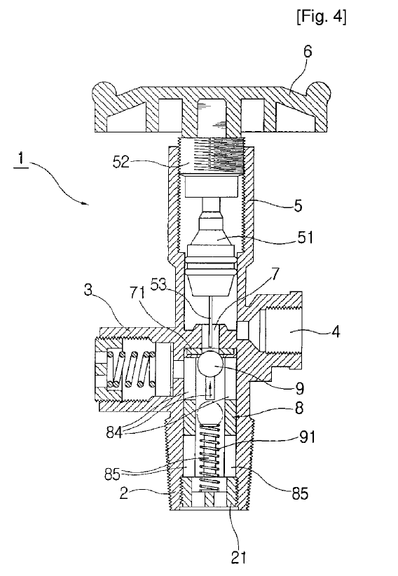

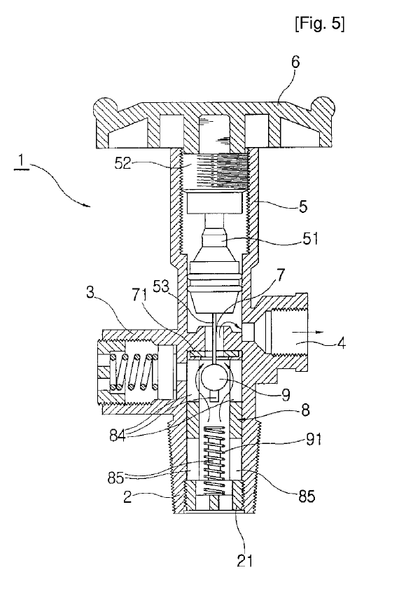

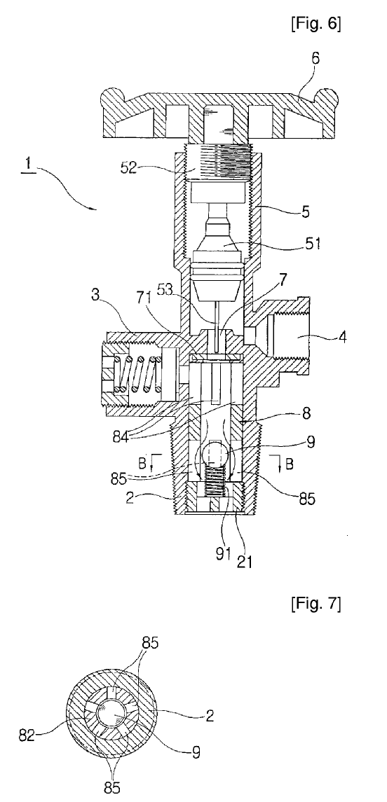

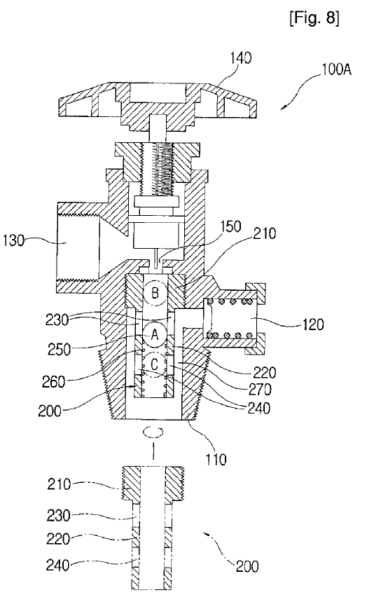

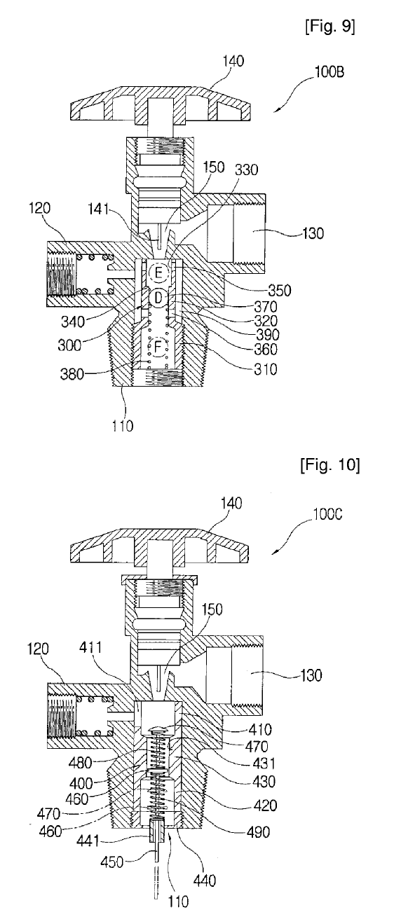

FIG. 1 is a sectional view showing an operation state wherein an overflow shutoff valve is actuated when gas is supplied normally, FIG. 2 is a sectional view taken along the line of A-A of FIG. 1, FIG. 3 is a perspective view of a cylinder mounted on the overflow shutoff valve according to the present invention, FIG. 4 is a sectional view showing a state wherein the overflow shutoff valve is actuated to stop a gas flow when the gas is overflowed, FIG. 5 is a sectional view showing an operation state of the overflow shutoff valve when the gas is recovered, FIG. 6 is a sectional view showing an operation state of the overflow shutoff valve when a gas container is refilled with the gas, and FIG. 7 is a sectional view taken along the line of B-B of FIG. 6.

The reference numeral 1 designates the overflow shutoff valve. The overflow shutoff valve 1 is detachably mounted on the upper end of the gas container, which is refilled with liquefied petroleum gas (not shown), in a screw type.

The overflow shutoff valve 1 includes a gas inlet 2 mounted on the gas container, a safety valve 3 for discharging internal pressure when the internal pressure of the gas container is rapidly increased, a gas outlet 4 for supplying gas to a gas appliance (for example, a gas oven range, a gas boiler, and so on), a controlling part 5 in which a valve stem 51 is mounted, and a valve handle 6 assembled to the upper end of the controlling part 5.

The upper end of the valve stem 51 mounted in the controlling part 5 for preventing gas leakage is connected to a stem assembling part 52 screwed to the controlling part 5, and the valve stem 51 has a control pin 53 protruding from the lower end thereof.

A gas inflow and outflow hole 7 is formed between the gas inlet 2 and the controlling part 5 for allowing inflow and outflow of the gas, and a packing 71 is mounted at the bottom of the gas inflow and outflow hole 7.

A characteristic of the present invention is to reduce a time period required for recovering remaining gas of the gas container and a time period for refilling the gas container with the gas by improving a structure of a cylinder 8 of which outer diameter is exactly fit for the inner diameter of the gas inlet 2 of the overflow shutoff valve 1, and the structure related with the inner diameter of the cylinder 8 and the outer diameter of a ball 9.

For the above, the cylinder 8 has an upper part 81, a lower part 82 and an intermediate part 83 between the upper and lower parts, each of which has the same thickness, and is made of a hollow pipe. The upper part 81 has a plurality of upper incised slots 84 of a narrow width and a uniform length vertically formed on the circumference thereof in an axial direction in such a manner as to be spaced apart from one another at regular intervals and be opened upwardly, and the lower part 82 has a plurality of lower incised slots 85 of a uniform length vertically formed on the circumference thereof in the axial direction in such a manner as to be spaced apart from one another at regular intervals and be opened downwardly.

In this case, the lower incised slots 85 can be formed at the lower part 82 in the opposite direction to the upper incised slots 84, and can have the same form and number as the upper incised slots 84 in order to make the gas flow smooth. The upper and lower incised slots 84 and 85 is configured such that the sum of plane sectional areas thereof is greater than a plane sectional area of the gas inflow and outflow hole 7.

The reason that the sum of the plane sectional areas of the upper and lower incised slots 84 and 85 is greater than the plane sectional area of the gas inflow and outflow hole 7 by making the width of each of the incised slots 84 and 85 narrow is to permit the ball mounted in the cylinder 8 to freely and smoothly perform a straight line motion in the axial direction without held to the incised slots 84 and 85 when the ball 9 is moved inside the cylinder 8, and to rapidly recover and refill the gas by allowing the flow of the gas greater than the gas flowing inside the gas inflow and outflow hole 7. Therefore, four to six upper incised slots 84 are formed on the upper part 81 of the cylinder 8 and four to six lower incised slots 85 are formed on the lower part 82 of the cylinder 8 in such a manner that the width of each of the upper and lower incised slots 84 and 85 is still smaller than the diameter of the ball 9 so as to prevent the ball 9 from being caught by the incised slots 84 and 85 and in such a manner as to have the sectional area of each incised slot for permitting the gas to be smoothly induced and discharged through the gas inflow and outflow hole 7.

In the drawing (see FIG. 3), five upper incised slots 84 and five lower incised slots 85 are respectively formed in the upper part 81 and the lower part 82. However, if one or two incised slots which are as wide as the ball 9 is separated from the inside wall surface the cylinder 8 are formed in the upper part and the lower part, the ball 9 is caught by the incised slots 84 and 85 which are wide, whereby the ball 9 cannot perform the straight line motion normally in the axial direction of the cylinder 8, and so, the shutoff valve cannot regulate the discharge of the gas. Therefore, it is preferable that the narrow upper and lower incised slots 84 and 85 are formed by four to six.

As described above, a number of the upper and lower incised slots 84 and 85 respectively formed in the upper and lower parts 81 and 82 of the cylinder 8 in order to induce the normal straight line motion of the ball 9 can reduce the time period for recovering the remaining gas of the gas container and also the time period for refilling the gas container with the gas. Operation of the present invention will be described as follows.

First, referring to the drawings, a normal operation of the overflow shutoff valve 1 will be described. FIG. 1 shows a state where the gas is discharged normally. At this time, the ball 9 is located at the central part 83 of the cylinder 8 in a state where the ball 9 is put on the upper end of the spring 91 supported on the cylinder supporter 21 screwed to the lower end of the gas inlet 2. Since the diameter of the ball 9 is smaller than the inner diameter of the central part 83 of the cylinder 8, the gas induced into the gas inlet 2 flows through the gap formed between the inner circumference of the central part 83 of the cylinder and the surface of the ball 9, so that the gas can be discharged normally.

Next, FIG. 4 shows an operation state of the ball 9 when the gas is excessively discharged to the gas outlet 4. If the gas is excessively discharged through the gas outlet 4 in abnormal, for example, if a gas supply hose is come off or torn, gas pressure induced into the gas inlet 2 is instantaneously increased, and hence, the ball 9 is moved toward the gas inflow and outflow hole 7 by the increased gas pressure and stops the gas inflow and outflow hole 7.

Next, FIG. 5 shows an operation state of the ball 9 when the remaining gas contained in the gas container is recovered. At this time, when a user turns upside down the gas container after manipulating the valve handle 6 in such a manner that the valve stem 51 is moved toward the gas inflow and outflow hole 7 and the control pin 53 passes the gas inflow and outflow hole 7 and appropriately protrudes toward the inside of the gas inlet 2, the ball 9 opens the gas inflow and outflow hole 7 by the control pin 53. At this time, the ball 9 is located at the central portion of the upper incised slots 84 of the cylinder 8, and hence, the remaining gas induced into the gas inlet 2 flows to the gas inflow and outflow hole 7 through the gap formed between the ball 9 and the upper part 81 and through the upper incised slots 84 as indicated by the arrow in FIG. 5. Since the sum of the plane sectional areas of the upper incised slots 84 is greater than the plane sectional area of the gas inflow and outflow hole 7, the amount of the gas flowing through the upper incised slots 84 becomes much than the amount of the gas flowing the gas inflow and outflow hole 7, whereby the time period for recovering the remaining gas contained in the gas container is reduced.

Finally, FIG. 6 shows a state where the gas container is refilled with the gas. The ball 9 elastically compresses the spring 91 by the gas pressure to the gas outlet 4 and moves toward the lower part 82 of the cylinder 8. At this time, since the ball 9 is located at the central portions of the lower incised slots 85, the gas refilled through the gas inflow and outflow hole 7 flows in the arrow direction of FIG. 6. At this time, since the sum of the plane sectional areas of the lower incised slots 85 is greater than the plane sectional area of the gas inflow and outflow hole 7, the amount of the gas induced into the gas inflow and outflow hole 7 rapidly flows downwardly through the lower incised slots 85 from the upper portion of the ball 9 without delay or stagnation inside the cylinder 8. Finally, the gas refilled through the gas outlet 4 rapidly flows without decrease of flow and fills the gas container, so that the refilling time period of the gas can be reduced.

As described above, the present invention can normally discharge the gas contained in the gas container, prevent overflow of the gas, and reduce the recovery time period and the refilling time period of the remaining gas of the gas container. Moreover, the cylinder 8 of the present invention does not have any stepped layer like the prior arts but has a simple structure that a number of the upper and lower incised slots 84 and 85 are respectively formed in the upper and lower parts of the hollow pipe, whereby a manufacturing cost of the overflow shutoff valve 1 can be reduced by saving material expenses and processing expenses of the cylinder 8.

### INDUSTRIAL APPLICABILITY

As described above, the present invention improves the structure of the cylinder and the structure related with the inside of the cylinder and the diameter of the ball which are the most important elements of the overflow shutoff valve, thereby reducing a manufacturing cost of the cylinder, and simply assembling the cylinder, the ball and the spring by inserting the cylinder, the ball and the spring into the gas inlet in order. Particularly, the present invention reduces the recovery time period of the remaining gas contained in the gas container and the refilling time period of gas. Additionally, the present invention is safe and reliable in use by always returning the ball to its original position and normally operating the ball after completing the recovery work and refilling work of the gas, and has a competitive price.

1. An overflow shutoff valve for a liquefied petroleum gas container, which comprises:
a gas inlet mounted at the gas container;
a safety valve protrudingly formed at one side of the upper portion of the gas inlet for discharging the internal pressure of the gas container when the internal pressure is rapidly increased;
a gas outlet protrudingly formed at the other side of the upper portion of the gas inlet for supplying gas to a gas appliance;
a valve handle for vertically controlling a valve stem mounted on a controlling part protruding from the upper portion of the gas inlet;
a gas inflow and outflow hole located between the gas inlet and the controlling part for allowing inflow and outflow of the gas;
a cylinder fit into the inner circumference of the gas inlet; and
a ball positioned inside the cylinder,
the cylinder and the ball being adapted to normally discharge the gas contained in the gas container and regulate a gas flow to prevent an excessive outflow of the gas,
wherein the cylinder has an upper part, a lower part and an intermediate part between the upper and lower parts, each of which has the same thickness, and is made of a hollow pipe, the upper part having a plurality of upper incised slots of a uniform length vertically formed on the circumference thereof in an axial direction in such a manner as to be spaced apart from one another at regular intervals and be opened upwardly, and the lower part having a plurality of lower incised slots of a uniform length vertically formed on the circumference thereof in the axial direction in such a manner as to be spaced apart from one another at regular intervals and be opened downwardly.

2. An overflow shutoff valve for a liquefied petroleum gas container according to claim 1, wherein four to six upper incised slots and four to six lower incised slots are respectively formed in the upper and lower parts of the cylinder so that the sum of plane sectional areas of the upper and lower incised slots respectively formed in the upper and lower parts of the cylinder is greater than a plane sectional area of the gas inflow and outflow hole

3. An overflow shutoff valve for a liquefied petroleum gas container according to claim 1, wherein the inner diameter of the cylinder is larger than the diameter of the ball.
